(19) United States
(12) Patent Application Publication
(10) Pub. No.: US 2003/0087078 A1
(43) Pub. Date: May 8, 2003

(54) Glass fiber mats

(76) Inventors: Ronald P. Desrosiers, Kitchener (CA); Robert M. Berscht, Elmira (CA)

Correspondence Address: Thomas A. Hodge, Baker, Donelson, Bearman & Caldwell, Suite 900, Five Concourse Parkway, Atlanta, GA, 30328, US

(21) Appl. No.: 10/041,882

(22) Filed: Nov. 1, 2001

(51) Int. Cl. B32B 27/04

(52) U.S. Cl. 428/297.4; 428/299.4

(57) ABSTRACT

Glass fiber mats having low solubility in vinyl monomers are made by providing a mat of glass fibers; applying a solid binder composition to the surface of the mat, wherein the binder composition comprises a solid unsaturated, uncured, curable polyester resin and an ultraviolet light initiator; heating the mat to melt the binder composition; and subjecting the mat to ultraviolet light to cure the binder composition.

### FIELD OF THE INVENTION

The present invention relates to glass fiber mats. In a more specific aspect, this invention relates to glass fiber mats having low solubility in vinyl monomers. This invention also relates to a process for the manufacture of glass fiber mats having low solubility in vinyl monomers.

### BACKGROUND OF THE INVENTION

The use of glass fibers for reinforcing plastics is well known in the prior art. More particularly, glass fibers can be made into chopped strand or continuous filament mats which are used to reinforce plastics.

Glass fiber mats commonly are composed of glass fibers and a binder material which binds the glass fibers together. Currently preferred binders are unsaturated polyester resins. These mats may be manufactured by applying the binder to a glass fiber mat and heating the treated mat in a conventional oven to melt the binder. This process results in the bonding of the binder to the glass fibers.

In many instances, depending on the intended use of the glass fiber mat, the industry needs a mat having a low solubility in vinyl monomers, such as styrene. Many of these instances involve compression molding, such as in a matched die molding process. For compression molding, the industry needs a glass fiber mat which does not dissolve rapidly in vinyl monomers.

There are methods in use to obtain glass fiber mats having low solubility in vinyl monomers. For example, a conventional method comprises the addition of a catalyst (such as benzoyl peroxide) to the binder and applying heat to force a cross-linking of the binder. However, as known in this industry, there is an inherent danger in using benzoyl peroxide.

Another conventional method of obtaining a glass fiber mat having low solubility in vinyl monomers involves the selection of a binder having a controlled chemical composition. Generally speaking, however, the solubility of the mat in vinyl monomers does not decrease to the desired level.

Other methods have been developed to meet the need for glass fiber mats having low solubility in vinyl monomers. For example, U.S. Pat. No. 4,054,713 (1977) uses a binder which is an unsaturated polyester resin powder made from specifically-defined dicarboxylic acid and polyol components.

U.S. Pat. No. 5,169,571 (1992) uses a liquid binder and, in the mat-forming process, the layers are compressed in stages and held in compression during staged curing.

Further, U.S. Pat. No. 5,703,198 (1997) describes a radiation curable binder composition for powder paint formulations in which the binder comprises an unsaturated polymer and a crosslinking agent, but there is no disclosure of using this composition in connection with glass fiber mats.

For various reasons, the glass fiber mats of the prior art have disadvantages, such as high energy input during the manufacturing process and discoloration of the glass fiber mat product. Thus, there is a need in the industry for an effective glass fiber mat which has low solubility in vinyl monomers and which avoids the disadvantages of the prior art.

### SUMMARY OF THE INVENTION

Briefly described, the present invention provides glass fiber mats having low solubility in vinyl monomers. The present invention also provides a process for the manufacture of glass fiber mats having low solubility in vinyl monomers.

As will be seen in greater detail below, the glass fiber mats of this invention are useful as reinforcing agents for plastics.

Accordingly, an object of this invention is to provide glass fiber mats.

Another object of this invention is to provide glass fiber mats in which the glass fibers are continuous filaments.

Another object of this invention is to provide glass fiber mats having low solubility in vinyl monomers.

Another object of this invention is to provide glass fiber mats which are useful as reinforcing agents.

Another object of this invention is to provide glass fiber mats which are useful as reinforcing agents for plastics.

Still another object of this invention is to provide a process for the manufacture of glass fiber mats.

Still another object of this invention is to provide a process for the manufacture of glass fiber mats in which the glass fibers are continuous filaments.

Still another object of this invention is to provide a process for the manufacture of glass fiber mats having low solubility in vinyl monomers.

Still another object of this invention is to provide a process for the manufacture of glass fiber mats which are useful as reinforcing agents.

Still another object of this invention is to provide a process for the manufacture of glass fiber mats which are useful as reinforcing agents for plastics.

Yet still another object of this invention is to provide a process for the manufacture of glass fiber mats in which the process does not require a high energy input.

Yet still another object of this invention is to provide a process for the manufacture of glass fiber mats in which the glass fiber mat product shows less discoloration.

Yet still another object of this invention is to provide a process for the manufacture of glass fiber mats in which the mat contains a solid unsaturated cured polyester binder which has been cured by ultraviolet light.

These and other objects, features and advantages of this invention will become apparent from the following detailed description.

### DETAILED DESCRIPTION OF THE INVENTION

The present invention relates to a glass fiber mat having low solubility in vinyl monomers, wherein the mat comprises glass fibers and an unsaturated polyester resin which has been cured by ultraviolet light.

The present invention also relates to a process for the manufacture of a glass fiber mat having low solubility in vinyl monomers, wherein the process comprises the sequential steps of providing a mat of glass fibers; applying a solid binder composition to the surface of the mat, wherein the binder composition comprises a solid unsaturated, uncured, curable polyester resin and an ultraviolet light initiator; heating the mat to melt the binder composition; and subjecting the mat to ultraviolet light to cure the polyester resin.

The glass fiber mats of this invention are useful when used as reinforcing agents for plastics, such as plastics used in pultrusion processes, matched metal die molding processes, resin injection molding processes, etc.

As noted above, the binder of this invention is cured by ultraviolet light rather than by heat.

According to this invention, the manufacture of glass fiber mats can be described as follows:

Glass fibers are laid down on a moving forming chain or belt such that the accumulation of fibers forms a loose mat of even weight distribution. The fibers can be drawn directly from a melt and laid down either as continuous filaments or chopped into strands of fixed lengths. The fibers can also be pulled from fiber cakes that have been pre-sized and dried.

This loose fiber mat then passes into a section where a solid binder (such as a powder) is applied to the surface of the mat. The binder can be applied using a cookie duster apparatus in which the binder is held in a hopper above a set of rollers, which feed out a controlled amount of powder. The speed of the rollers is set depending on the amount of glass fibers being laid down and the speed of the moving belt, such that the desired binder percentage is maintained in the mat. The dry binder could also be sprayed. If the binder is applied in the dry state, a fine water spray can be applied to the glass fiber mat to help hold the binder in place, thus preventing the binder from falling directly through the mat. The chain holding the mat is also vibrated or shaken to help distribute the binder evenly through the thickness of the mat.

A common alternate method of applying the binder is to prepare a slurry in water (not a solution) in which the binder is held in suspension by constant agitation and re-circulation, and the glass mat is saturated with this slurry in such a way that the binder percentage is controlled. The slurry can also contain other additives to enhance the performance of the finished mat product. Typical binder concentrations in this invention are between about 2-7%, based on the weight of the finished mat product.

The present invention can be used with any of these binder application techniques.

The binder used in this invention is a solid unsaturated, uncured, curable polyester resin. This polyester has a degree of unsaturation between about 100 and 1500 grams per mole of unsaturated group, a molecular weight between about 800 and 7000 and a melt viscosity between about 1-200 poise at 150° C.

The unsaturated groups in the polyester binder can be located within the polyester chain or at the end of the chain.

The degree of unsaturation for the polyester is preferably between about 100-600 grams per mole of unsaturated group. The molecular weight is preferably between about 3500-5500. The unsaturated polyester can be (semi) crystalline or amorphous. Generally, an advantage of crystalline unsaturated polyesters over amorphous unsaturated polyesters is that stable powders with lower viscosity and better flow rates can be more easily prepared. The melting point of the (semi) crystalline unsaturated polyester is between about 80°-180° C., preferably between about 100°-130° C.

Preparation of the unsaturated polyester can be carried out in a one-step process in which unsaturated polyfimetional carboxylic acids and diols are heated to a temperature, for example, between about 180° C. to about 230° C. for about 6 to about 20 hours.

In general, the unsaturated polyester is obtainable from the condensation of one or more aliphatic or cycloaliphatic mono-, di- or polyfunctional carboxylic acids, or mixtures thereof, and if desired, a monofunctional carboxylic acid or the corresponding ester of this monofunctional carboxylic acid. In preferred embodiments set forth below, an ethylene glycol/fumarate solid polyester is used. The aforementioned ethylene glycol/fumarate is obtained by a polycondensation reaction of 1 mole of ethylene glycol with 1 mole of fumaric acid.

Examples of suitable alcohols and glycols include benzyl alcohol, ethylene glycol, propylene glycol, neopentylglycol, butanediol, hexanediol, dimethylol cyclohexane, diethylene glycol, glycerol, trimethylol propane, pentaerytritol, dipentaerythritol and mixtures thereof. Instead of an alcohol or glycol, or together with an alcohol or glycol, one or more epoxy compounds (for example, ethylene oxide, propylene oxide, allyl glycidyl ether or mixtures thereof) can be used.

Examples of suitable di- or polyfunctional carboxylic acids include maleic acid, fumaric acid, itaconic acid, citraconic acid, malonic acid, succinic acid, glutaric acid, adipic acid, sebacic acid, 1, 4-cyclohexane dicarboxylic acid, hexahydrophthalic acid, hexachloroendomethylenetetrahydrophthalic acid, isophthalic acid, terephthalic acid, trimellitic acid or mixtures thereof. Fumaric acid, maleic acid or mixtures thereof is preferred. The carboxylic acids can also be applied in the corresponding anhydride form so that, for example, tetrahydrophthalic anhydride, maleic anhydride, phthalic anhydride or mixtures thereof can be used.

If desired, the unsaturated polyester can also be obtained from saturated or unsaturated monofunctional carboxylic acids or mixtures thereof. These monofunctional carboxylic acids include, for example, synthetic or natural fatty acids having 2 to 36 carbon atoms.

Corresponding esters of monofunctional alcohols such as glycerol are used for esterification. Examples of suitable monofunctional carboxylic acids include lauric, stearic, oleic, linoleic, benzoic, acrylic, methacrylic acid or mixtures thereof. The unsaturated polyester can also contain dicyclopentadiene.

Common additives such as pigments, fillers, flow promoters, stabilizers or mixtures thereof can be used, as known to those skilled in the art. Suitable pigments include, for example, inorganic pigments such as titanium dioxide, zinc sulphide or iron and chromium oxide, and organic pigments such as azo compounds. Suitable fillers include, for example, metal oxides, silicates, carbonates, sulfates or mixtures thereof.

Any number of unsaturated solid polyesters could be used provided the reactivity is high enough that the mat shows low solubility in vinyl monomers when cured by UV. Other requirements of the polyester are that the crystalline melting point or glass transition temperature is high enough to prevent the ground powder from blocking or caking under normal storage and handling conditions. Another requirement is that the melting point must allow the binder to flow at a temperature low enough to prevent yellowing (i.e., discoloration) of the mat during the melting stage.

The binder used in the invention differs from those used for thermally cured mats in that the binder is compounded with a UV light initiator system. We have used a bis(2,4,6-trimethylbenzoyl) phenyl-phosphine oxide (BTPPO) which falls into the bis-acyl-phosphine oxide (BAPO) type of initiators. An example is Irgacure 819 from Ciba Specialty Chemicals. Other BAPO types can also be used. In addition, other light initiators suitable for use in the present invention include, but are not limited to, alpha-hydroxy-acetophenones. Levels of about 0.25% to about 1.0% are preferred, but higher or lower levels can also be used.

The ultraviolet light initiator can be added to the molten resin, which is then allowed to solidify and is ground. The initiator can be added in bulk or added as an in-line extrusion. An alternate method of preparing the binder is to dry blend the initiator into the pre-ground polyester. The preferred mixing method is the melt method, which makes more efficient use of the initiator and allows lower levels of the initiator to be used.

After the binder has been applied to the glass fiber mat in the correct ratio and the binder is evenly distributed throughout the thickness of the mat, the wet glass is heated to evaporate the water and melt the binder. This allows the binder to flow over the surface of the glass fibers and form mechanical bonds at the interstices of the glass fibers. This can be done using forced air ovens that are set in the temperature range of 180-250° C. At this point, under normal thermal cure, the mat would be held at a higher temperature for a period of time sufficient to allow the binder to completely cure. Line speeds are generally in the 20-50 ft/minute range and are currently limited by the cure of the binder.

In this invention, sufficient heat need only be applied to evaporate the water from the mat and melt the binder. This can be done using convection ovens, but can also be done using heated rollers, radio frequency energy, etc. Once the binder has melted and flowed, the mat is passed under a focused UV light source where the mat undergoes full cure. This invention has effectively used 600 watt/inch microwave lamps with V-Type UV bulbs from Fusion UV Systems, Inc. Experiments have been carried out using different light intensities to establish potential improvements in line speeds. Based on these experiments, a significant increase in production line speed is believed possible by the addition or incorporation of a UV light source on the production line, thus eliminating the cure of the binder as the limiting factor for line speed.

Once the binder has been cured, the mat is cooled and wound on a roll at the end of the machine. The roll is trimmed and can be subsequently slit to produce the finished mat products. The mat products made according to this invention can be used in most fiber reinforced plastics applications, but are especially useful in the areas of resin transfer molding and pultrusion, where advantage is taken of the low solubility in vinyl monomers.

Glass fiber mats produced using the method of this invention give superior performance with respect to solubility in a styrene monomer than mats made using conventional thermal cure. This indicates that the potential exists to run with lower heat requirements and/or faster line speeds using this invention. The mats of this invention also have less discoloration than mats made with standard binders.

The present invention is further illustrated by the following examples which are illustrative of certain embodiments designed to teach those of ordinary skill in the art how to practice this invention and to represent the best mode contemplated for carrying out this invention.

### EXAMPLE 1

Using an ethylene glycol/fumaric acid polyester binder with UV light initiators and high intensity UV light, as described above, an insoluble chopped strand mat is produced on an experimental mat line. The UV cured mat is then tested and compared to a heat cured mat made on the same machine using the above mentioned polyester binder, which contains benzoyl peroxide (BPO).

Samples of chopped strand glass mats are produced by incorporating various production parameters and binder compositions. The goal of this study is to determine whether binders with UV light initiators could produce chopped strand mats with comparable or superior properties to conventional BPO cured mats, at a faster rate, better color and possibly lower cost than the current mat line technology. While most insoluble glass mats made today are made from continuous glass filaments, rather than chopped glass, we expect that comparative results from the experimental line will be translatable to the continuous filament production lines.

The first phase in the trial is to produce the EG/FA binder and unsaturated polyester containing the initiator. Four different trial binders are produced and given sample numbers to distinguish between them. Two of the binders have the UV initiator added directly to the melted alkyd prior to crystallization. Sample 1 contains 0.25% of the UV initiator, and Sample 2 contains 0.5% initiator. The initiator is added to the melt in each case, and mixed into the alkyd by an air driven mixer. This material is allowed to solidify as normal alkyd, then processed into chunks and ground to a powder of an average size of 120 microns.

To produce Samples 3 & 4, the UV initiator is dispersed into the ground resin powder by tumbling. Sample 3 contains 0.5% initiator, and Sample 4 contains 1.0% initiator. The initiator used in this trial is Irgacure 819.

The four binders are run on a pilot mat line. Two 10 inch F-600-V high intensity UV lights systems are employed. These are installed on the mat line at the exit to the oven.

Following is a brief description of how the pilot mat line operates to produce chopped strand mat. Many spools of continuous glass strands are fed together into a chopper to chop the glass fibers into 2-inch strands which then immediately enter a forming chamber where the distribution is randomized. The glass fibers then fall on a moving belt at a set speed and pass over a spray zone, where water moistens the mat so that the binder will adhere. The mat then passes under the binder applicator, where binder is applied at a desired rate. Next, the line moves through a zone where the belt is vibrated, which results in the slight compaction of the mat and an even distribution of binder.

Finally, the wet mat coated with binder enters a forced air oven that has two temperature zones. Conventional BPO cured mat requires high temperature ovens to melt and then cure the binder as the line moves along. The temperature of the oven zones can be varied, but are typically set around 250° C. in the first zone and 230° C. in the second zone. The mat exits the oven and travels a short distance in which the mat cools before being rolled onto a cardboard tube for storage.

In the case of the UV cured glass mat, the UV lights are positioned directly after the second oven zone. This is where the UV cure occurs.

The intensity of the light is varied to replicate different line speeds rather than run the line at different speeds. The line speed and binder content are held constant, and the UV lamp light intensity is varied to determine the effect of varying UV exposure on the degree of cure. The mat produced in the above mentioned line is approximately 12 inches wide and samples of approximately 10 feet in length are collected under each set of conditions.

Table I lists the conditions and binder types which are run during the trial. After all trial parameters are run, the glass mat samples are subjected to the following tests.

Soxhlet extractions are run on each of the 16 glass mat samples. Depending on the quantity of the sample, 2 or 3 test pieces are removed from various locations along the length of each sample. Each test piece is then subjected to a one-hour reflux with acetone. At the end of this time, the glass fiber mat is dried, and the weight recorded and calculated. The lower the weight loss, the higher the degree of cure.

Loss on ignition (LOI) tests are run on 12 test strips from each mat sample.

TABLE I

| | | Oven | |
|---|---|---|---|
| | | Temper- | |
| | | atures | |
| | | ° C. | Line |
| MAT LINE TRIAL | UV Light | Zone 1/ | Speed |
| CONDITIONS | Intensity, % | Zone 2 | ft/min. |
| Control | No Light | 220/210 | 10 |
| Control | No Light | 250/240 | 10 |
| Sample 1 | 100 | 220/210 | 10 |
| (Melt, 0.25% Irgacure 819) | | | |
| Sample 1 | 50 | 220/210 | 10 |
| Sample 2 | 100 | 221/190 | 10 |
| (Melt, 0.5% Irgacure 819) | | | |
| Sample 2 | 200 | 220/210 | 10 |
| Sample 2 | 100 | 220/210 | 10 |
| Sample 2 | 75 | 220/210 | 10 |
| Sample 2 | 50 | 210/210 | 10 |
| Sample 2 | 25 | 220/210 | 10 |
| Sample 2 | No Light | 220/210 | 10 |
| Sample 3 | 100 | 220/210 | 10 |
| Sample 3 | 50 | 220/210 | 10 |
| Sample 4 | 100 | 220/210 | 10 |
| (Dry Mix, 1.0% Irgacure) | | | |
| Sample 4 - repeat | 100 | 220/210 | 10 |
| Sample 4 | 50 | 220/210 | 10 |

These test pieces measuring 1 inch by 12 inches are removed from different locations along the length of the sample. LOI tests are run on the test pieces. The LOI tests are run in a muffle oven set at 700° C. for one hour.

Styrene solubility is performed on fifteen of the 1 inch by 12 inch strips. Each test piece is suspended in styrene with a weight affixed to the lower end. A timer is started when the test piece is submerged in styrene and stopped when the test piece breaks. If the test piece lasts 30 minutes under a given weight, then another test piece from the same sample is submerged with an increased weight load added. The test continues for each sample until all strips are used or until a sample passes the 400-gram load for 30 minutes.

Averages are calculated and reported for the Soxhlet Extraction results. The Average Styrene Solubility Factors are calculated using a formula which takes into account both the time taken for a strip to break when submerged in styrene and the weight used to load the strip. The Average Styrene Solubility Factor is defined as time in seconds before breaking multiplied by the weight in grams attached on the end of the glass strip. The total is averaged for each group of strips tested.

Test results are displayed in Table II.

TABLE II

| SUMMARY OF | | | |
|---|---|---|---|
| GLASS MAT | Soxhlet | Loss on | Styrene |
| TEST RESULTS | Extraction | Ignition | Solubility |
| Sample | Averages (%) | Averages (%) | Factor |
| Standard, 220/210 C. | 96 | 10.1 | 16.33 |
| cure temp. | | | |
| Standard, 250/240 C. | 96.3 | 9.2 | 187.43 |
| cure temp. | | | |
| Sample 1 (Melt, | 96.3 | 9.7 | 275.71 |
| 0.25% Irgacure 819), | | | |
| 100% UV | | | |
| Sample 1, 50% UV | 94.7 | 10 | 90.46 |
| Sample 2 (Melt, | 97 | 10.2 | 562.5 |
| 0.5% Irgacure 819) | | | |
| 100% UV | | | |
| Sample 2 Repeat | 97.4 | 10.5 | 91.03 |
| Sample 2 220/190 C. | 97.5 | 9.8 | 225.65 |
| Sample 2 220/210 C., | 96.7 | 9.1 | 168.68 |
| 75% UV | | | |
| Sample 2, 50% UV | 95.6 | 9.8 | 22.15 |
| Sample 2, 25% UV | 93.1 | 10.5 | 1.38 |
| Sample 2, No UV Light | 93.2 | 10.3 | 1.64 |
| Sample 3 (Dry Mix, | 95.2 | 10 | 46.81 |
| 0.5% Irgacure 819), | | | |
| 100% UV | | | |
| Sample 3, 50% UV | 94.6 | 10 | 13.99 |
| Sample 4, Dry Mix, | 97 | 9.4 | 359.63 |
| 1.0% Irgacure 819), | | | |
| 100% UV | | | |
| Sample 4, Repeat | 97 | 10 | 315.4 |
| Sample 4, 50% UV | 95.4 | 9.7 | 47.71 |

In an attempt to demonstrate the differences in color of the glass mat, certain samples are tested on a Hunter Lab color computer using the E313 yellow index. The results are shown in Table III.

TABLE III

| | YELLOW INDEX |
|---|---|
| SAMPLE | VALUE |
| Standard, Oven Temp. - 220/210 C. | 11.57 |
| Standard, Oven Temp. - 250/240 C. | 12.05 |
| Sample 1 (Melt, 0.25% Irgacure 819), | 10.66 |
| 100% UV Intensity | |
| Sample 2 (Melt, 0.5% Irgacure 819), | 11.07 |
| 100% UV Intensity | |
| Sample 2 (Melt, 0.5% Irgacure 819) | 11.68 |
| No UV Light | |
| Sample 3 (Dry Mix, 0.5% Irgacure 819), | 10.67 |
| 100% UV Intensity | |
| Sample 4 (Dry Mix, 1.0% Irgacure 819)m | 10.95 |
| 100% UV Intensity | |

The Styrene Solubility Factor is probably the most important indicator of the degree of cure obtained in these evaluations. The acetone extraction numbers also corroborate these results although the variations are less extreme due to the limited solubility of the binder in this solvent in the uncured state. Using this data, if we assume that the standard cure at 250° C. can be used as a benchmark, we can conclude the following:

1. Oven temperatures can be reduced using UV cure with the potential to match or improve the styrene solubility of standard products.

2. Even at lower oven temperatures, the potential exists to increase line speed by at least 50% to 150% without loss of cure. Greater speeds can be achieved by increasing the number of UV lamps on the table.

3. The binder preparation method of melt mixing the initiator is preferable over the dry mix method with respect to cure. Melt mixing would allow lower levels of initiator to be used and/or will permit faster line speeds.

The testing clearly shows that yellowing of the mat is related to the oven temperature and the BPO content of the binder. These results demonstrate that UV cure can achieve the desired cure and reduce the overall discoloration of the finished mat.

The present invention has been described in detail with particular reference to certain embodiments, but variations and modifications can be made without departing from the spirit and scope of the invention as defined in the following claims.

What is claimed is:

1. A glass fiber mat having low solubility in vinyl monomers, wherein the mat comprises glass fibers and an unsaturated polyester resin which has been cured by ultraviolet light.

2. A glass fiber mat as defined by claim 1 wherein the glass fibers are continuous filaments.

3. A glass fiber mat as defined by claim 1 wherein the polyester resin is derived from ethylene glycol and fumaric acid.

4. A glass fiber mat as defined by claim 1 wherein the polyester resin is derived from ethylene glycol and malic anhydride.

5 . A process for the manufacture of a glass fiber mat having low solubility in vinyl monomers, wherein the process comprises the sequential steps of:
A. providing a mat of glass fibers;
B. applying a solid binder composition to the surface of the mat, wherein the binder composition comprises a solid unsaturated, uncured, curable polyester resin and an ultraviolet light in itiator;
C. heating the mat to melt the binder composition; and
D. subjecting the mat to ultraviolet light to cure the polyester resin.

6. A process as defined by claim 5 wherein the glass fibers are continuous filaments.

7. A process as defined by claim 5 wherein the polyester resin is derived from ethylene glycol and fumaric acid.

8. A process as defined by claim 5 wherein the polyester resin is derived from ethylene glycol and malic anhydride.

9. A process as defined by claim 5 wherein the ultraviolet light initiator is a mono-acyl phosphine oxide.

10. A process as defined by claim 5 wherein the initiator is a bis-acyl phosphine oxide.

11. A process for the manufacture of a glass fiber mat having low solubility in vinyl monomers, wherein the process comprises the sequential steps of:
A. providing a heated mat of glass fibers;
B. applying a solid binder composition to the surface of the mat, wherein the binder composition comprises a solid, unsaturated, uncured, curable polyester resin and an ultraviolet light initiator;
C. melting the binder composition; and
D. subjecting the mat to ultraviolet light to cure the polyester resin.

12. A process as defined by claim 11 wherein the glass fibers are continuous filaments.

13. A process as defined by claim 11 wherein the polyester resin is derived from ethylene glycol and lumaric acid.

14. A process as defined by claim 11 wherein the polyester resin is derived from ethylene glycol and malic anhydride.

15. A process as defined by claim 11 wherein the ultraviolet light initiator is a mono-acyl phosphine oxide.

16. A process as defined by claim 11 wherein ultraviolet light initiator is a bis-acyl phosphine oxide.

17. A glass fiber mat having low solubility in vinyl monomers and manufactured by a process which comprises the sequential steps of:
A. providing a mat of glass fibers;
B. applying a solid binder composition to the surface of the mat, wherein the binder composition comprises a solid, unsaturated, uncured, curable polyester resin and an ultraviolet light initiator;
C. heating the mat to melt the binder composition;
D. subjecting the mat to ultraviolet light to cure the polyester resin.

18. A process as defined by claim 17 wherein the glass fibers are continous filaments.

19. A process as defined by claim 17 wherein the polyester resin is derived from ethylene glycol and fumaric acid.

20. A process as defined by claim 17 wherein the polyester resin is derived from ethylene glycol and fumaric acid.

21. A process as defined by claim 17 wherein the polyester resin is derived from ethylene glycol and malic anhydride.

22. A process as defined by claim 17 wherein the ultraviolet light initiator is a mono-acyl phosphine oxide.

23. A process as defined by claim 17 wherein the ultraviolet light initiator is a bis-acyl phosphine oxide.
